(19) United States
(12) Patent Application Publication
(10) Pub. No.: US 2006/0160060 A1
(43) Pub. Date: Jul. 20, 2006

(54) Educational children's video

(76) Inventor: Ilham Algayed, Evanston, IL (US)

Correspondence Address: Paul E Schaafsma, Suite 221, 521 West Superior, Chicago, IL, 60610, US

(21) Appl. No.: 11/038,316

(22) Filed: Jan. 18, 2005

(51) Int. Cl. G09B 25/00

(52) U.S. Cl. 434/365

(57) ABSTRACT

A children's video in accordance with the present invention provides multiple stimuli that introduce various learning concepts to infants and young children based on their age specific developmental abilities. A video in accordance with the present invention includes content designed to enhance vision development, hearing and speech development, and learning directed at a particular age group. A series of educational children's videos can be provided having a first video for a first, younger age group and a second video for a second, older age group. The first video introduces images and sounds appropriate for the particular age group. The second video uses the sights and sounds from the first video to introduce more complexity, such as for example breaking down realistic images into their symbolic counterparts and changing graphical images from two to three dimensional shapes.

### FIELD OF THE INVENTION

The present invention relates to educational videos.

### BACKGROUND OF THE INVENTION

There is a significant market for juvenile videos. Examples of titles in the juvenile video market include Dora the Explorer—which follows a 7-year-old Latino girl and her friends in a play-along, computer-style adventure; Blue's Clues—which involves a live-action host named Joe and a bright blue animated puppy named Blue who invite viewers into their computer-animated storybook; Jay Jay—an animated jet plane and his friends; Clifford: The Big Red Dog—an animated show that follows Clifford, a 20 foot tall red dog, who plays with his dog friends, Cleo and T-Bone, and Emily Elizabeth, his owner; the Wiggles—a show featuring a live Australian musical group; Bob the Builder—an animated construction worker; and Thomas the Tank Engine—an animated show which follows Thomas, a train engine, and his friends. These titles all require basic vocabulary skills from the viewer and are designed for entertainment of the viewer.

Examples of video titles for younger children include Sesame Street/the Muppets and Barney. Barney follows the exploits of a large purple dinosaur who emerges out of the imagination of a pre-school class. Sesame Street/the Muppets refers to the ubiquitous puppets created by the Jim Henson Company for the Public Television classic, Sesame Street. While directed at younger children, titles such as the Muppets and Barney still require basic vocabulary skills from the viewer and are designed for entertainment of the viewer.

In 1997, a genre of children's videos was introduced that was directed at children younger than eighteen months of age which did not require basic vocabulary skills on the part of the viewer. The Teletubbies television show first debuted in the U.K. It featured Tinky Winky, Dipsy, Laa-Laa, and Po, four human-like creatures dressed in combined space/rabbit costumes who speak baby talk and live in Teletubbyland, a world that has been described as a post-nuclear landscape caught in sunshine. The Teletubbies live in a dome-shaped home where a vacuum cleaner, Noo-noo, cleans up after them. The Teletubbies can receive television pictures via monitors displayed on their tummies. These pictures are of young children showing an aspect of their own experience in their world. However, Teletubbies makes no claim to educating young children, instead focusing on entertainment: “The first rule is go straight for the comedy—if it isn't funny, it isn't Teletubbies.” Andrew Davenport, Co-creator and writer of Teletubbies (http://pbskids.org/teletubbies/parentsteachers/progsummary.html).

At about the same time, the Baby Einstein video series quietly entered this new genre. Julie Aigner-Clark, a new mom who formerly taught English and art, started the Baby Einstein Company in 1996. She created this line of videos as a way to expose her daughter to the humanities from a baby's perspective. The videos combine classical music and simple, colorful, real world images. Each video in this series targets children within a wide age range (i.e. “birth and up”, “9 months and up”, “one year and up”) and is subject specific, with titles such as Baby Noah™ Animal Expedition, Baby MacDonald™ A Day on the Farm, Baby Bach™ Musical Adventure, Baby Beethoven™ Symphony of Fun, Baby Mozart™ Music Festival, Baby Galileo™ Discovering the Sky, Baby Neptune™ Discovering Water, Baby Newton™ Discovering Shapes, and Language Nursery. Reportedly, 90% of the infant videos sold last year in the U.S. were part of the Baby Einstein line.

Interestingly, although the name “Baby Einstein” conjures up images of superior intelligence, the Baby Einstein Company's website explicitly disclaims any educational content: “Baby Einstein products are not designed to make babies smarter. Rather, Baby Einstein products are specifically designed to engage babies and provide parents with tools to help expose their little ones to the world around them in playful and enriching ways—stimulating a baby's natural curiosity.” www.babyeinstein.com.

Other similar products include the Baby Development Collection from Fisher Price and the Baby Genius videos from Genius Products Inc. The Baby Development Collection offers four titles (Music Baby, Baby's Day, Nature Baby, and Baby Moves) and is touted as containing “adorable puppet friends, playful poetry, delightful music, and live footage of lots of babies, children, moms and dads”. Like the Baby Einstein videos, these Fisher Price videos are subject specific and target children within a wide age range. They also follow Baby Einstein's lead in disclaiming educational content. The Baby Development Collection tag line reads: “An entertaining line of videos and DVDs for you and your little one.” Likewise, the Baby Genius videos are subject specific with titles such as “Baby Genius Mozart & Sleepy Time Friends”, “Baby Genius Animal Adventures,” and “Baby Genius Favorite Children's Songs” and target children within a wide age range.

Two less visible offerings do make claims that their video products help infants learn. The first is the BabyBumbleBee BeeSmart videos offered by Educational Products for Infancy, Inc. of Crystal Beach, Fla. (http://www.babybumblebee.com/). This website claims that these videos utilize a “scientifically well established teaching method” identified as “Paired Associative Learning.” According to the site, this type of learning “refers to experiencing two stimuli at once or in close proximity and beginning to associate them.” The website further describes the featured paired stimuli in the videos as objects and their associated spoken words. These videos include a five volume Vocabulary Builder Series, a three volume Action Words Series, a two volume BumbleBee's 123s Set, and a three volume Early Learning Series. According to the website, each of the Vocabulary Builder Series videos features a very specific topic (e.g., 23 new nouns per video) and targets are very broad age range (e.g., two months and up).

The second offering is the So Smart! videos offered by The Baby School Company, Inc. d.b.a. So Smart! Productions (http://www.sosmart.com/). This website claims their video “is the only available educational video series for its age group that has been created by a producer with a background in both art and early childhood development.” Like the BabyBumbleBee BeeSmart videos, the So Smart! videos focus on “naming things as they appear.” The series features fully-animated original content consisting of large, slow moving images and ballet-like imagery, choreographed to gentle music with no sudden motions or “jump cuts.” Offered videos include two animated early childhood educational video series: So Smart! for infants and toddlers, ages three months to three years, and King Otis and the Kingdom of Goode for preschoolers, ages three to six years of age. Each video in The So Smart! series features such topic specific titles as: Sights & Sounds, Shapes, Letters, Colors, Musical Instruments, First Words, and Spanish. Again, each video is targeted at ages “3 mos. to 36 mos.”

Thus, the most “educational” infant video offerings are based on experiencing two stimuli at once and naming objects as they appear. However, recent scientific studies on infant and child brain development have found that higher functions such as learning and intelligence are dependent upon exposure to a wide array of particular auditory and visual stimuli within certain narrowly defined periods in the first eighteen months of life. What would thus be desirable would be children's videos designed to improve the learning capacity of young children.

### SUMMARY OF THE INVENTION

A children's video series in accordance with the present invention is designed to improve the learning capacity of young children. A children's video in accordance with the present invention provides multiple stimuli that introduce various learning concepts to infants and young children based on their age specific developmental abilities. Each video includes content designed to enhance vision development, hearing and speech development, and learning directed at a particular age group. A first video can be provided for a first, younger age group and a second video for a second, older age group. The first video introduces images appropriate for a first, specific age group. The second video uses images from the first video to introduce more complexity such as, for example, breaking down realistic images into their symbolic counterparts and changing graphical images from two to three dimensional images.

### BRIEF DESCRIPTION OF THE DRAWINGS

FIG. 1 is a storyboard of a first example video in accordance with the principles of the present invention.

FIG. 2 is a storyboard of a second example video in accordance with the principles of the present invention.

### DETAILED DESCRIPTION OF THE INVENTION

Recent advances in pediatric neuroscience reveal that a child's brain grows and develops dramatically in the first eighteen months of life. It is during this period of rapid brain growth that a child develops her specific patterns of thinking and responding, which ultimately lead to learning and intelligence.

Prior to these discoveries, it was thought that the structure of a child's brain was fully developed at birth and that it was an exact copy of the genetic codes of the parents. Experts further believed that a child's ability to learn was entirely dependent on her genetic potential. Scientists now know that while genetics do play a role in determining a child's skills and abilities, a child's environment and experiences within that environment play an equally important role in that child's potential for overall learning and intelligence. In other words, higher brain functions such as learning and intelligence develop after birth as a direct consequence of a baby's experience within her environment.

Neuroscientists have also recently discovered that there are certain periods in a child's life when she is particularly sensitive to her environment. It is during these critical periods of brain growth and development that the neuronal circuits within the brain responsible for such phenomena as vision, language acquisition, and memory become established. The majority of these critical periods occur during the first eighteen months of a child's life. It is during these eighteen months—when patterns for thinking, responding, and problem solving are being established—that the human brain has the greatest potential for learning.

Repeated exposure to certain visual and auditory stimuli during this critical period can positively influence and strengthen a child's brain cell circuitry. The more a child is exposed to and engages in certain developmental activities, the stronger the connections develop between specific brain cells. The stronger these connections are, the better the learning of that particular developmental skill. For example, infants who receive more language stimulation by being read or talked to during the first several months of life acquire more advanced language skills than similar age counterparts without the same verbal exposure.

In the past, scientists and developmental specialists believed that language skills developed before reading and writing. Recent research supports the idea that language, reading, and writing skills develop simultaneously. The current scientific data suggests that development of each of these skills is closely linked to and dependent on each of the other skills.

Further, studies show that the process of learning spoken and written language skills begins in early infancy and develops in a fairly organized and sequential pattern during the first eighteen months of life. Language, reading, and writing depend on the acquisition of earlier developmental skills such as listening and paying attention to stories, interacting with pictures in books, recognizing images in books, and verbally interacting with people regarding these stories and book images. Children develop these skills over the first eighteen months of life as they listen to stories, play with books, sing nursery rhymes, and scribble on paper. These skills are fine-tuned with repetition: the more children have the same stories told to them or the same songs sung to them, the more they learn and the better their language and literacy development.

Videos in accordance with the principles of the present invention have been developed from insights gleaned from these recent discoveries. The importance of these types of visual and auditory stimuli in this skill acquisition process establishes the basis for the sights and sounds seen and heard in videos in accordance with the present invention. Visually, babies typically learn realistic symbols such as photographs first and then later begin to understand more abstract symbols like line drawings and letters. In the first videos in accordance with the present invention, infants are introduced to realistic photos of familiar objects and images in their world. In subsequent videos in accordance with the present invention, some of these realistic objects and images are broken down into their symbolic counterparts (e.g., line drawings; 3-dimensional graphic forms).

From a speech and language perspective, infants and young children learn by mimicking what they hear. Associating these sounds with corresponding images further enhances their speech production. In videos in accordance with the present invention, infants and toddlers learn about sounds and word structure through exposure to books in an electronic format containing familiar characters, objects, and events. They also begin to identify letters of the alphabet through these books because the letters are linked to familiar objects and the sound of each letter is stressed repeatedly through alliteration and rhyming. As infants become toddlers, they begin to understand the sequence of a story (i.e. beginning, middle, and end) as well as understand the written words within that story used to symbolize ideas and thoughts. In later videos for toddlers, the images become more complex as does the accompanying text and narration. The sights and sounds in videos in accordance with the present invention are repeated over and over again in interesting and stimulating ways, often accompanied by music and/or song because repetition is key to learning in infants and young children.

In more detail, videos in accordance with the present invention focus on three interrelated areas of development: vision, hearing and speech development, and learning. With respect to vision, babies are born with peripheral vision. They can generally only see about eight to 15 inches in front of them. As newborns, they show preference for the human face, especially close-ups. Over the first few weeks of life, they gradually acquire the ability to focus closely on a single object in the center of their visual field as well as on distant objects. By one month of age, a baby can focus briefly on things as far away as three feet. At this stage, babies also learn to track or follow moving objects. Although at one month of age an infant can only follow large, slow moving objects in a limited visual range, by two or three months of age he can track even small, fast-moving objects through a wider visual field.

At birth, babies are extremely sensitive to bright light. By two weeks of age, as their pupils enlarge, babies can experience a broader range of light and dark shades. The more contrast in a pattern, the more babies are attracted to the pattern. Babies are initially most attentive to black and white pictures or pictures with high contrast patterns such as sharply contrasting stripes, checkerboard patterns, bull's eyes or very simple faces. Color vision does not fully develop until four months of age, at which time an infant is able to distinguish not only the full range of colors, but also many shades. Interestingly, studies have shown infants this age initially prefer the color red to other colors in the spectrum.

Babies this age also begin to show a preference for increasingly complex patterns and shapes. At one month of age, an infant's favorite patterns are simple linear images such as big stripes or checkerboards. By three months of age, the same infant prefers circular patterns such as bull's eyes and spirals. That is one reason why the human face, which is full of circles and curves, is so appealing to infants at this age. By two or three months of age, a baby has increased visual coordination and can move both eyes simultaneously for better focusing. He now has depth perception and the ability to track objects as they move toward and away from him. By four months of age babies can focus on images that rotate horizontally or vertically as well as images that move back and forth. Interestingly, studies show that this is somewhat easier for boys to grasp since girl infants do not integrate visual objects in space as well as boy infants at this age.

By three months of age, a baby's visual field expands to take in an entire image as opposed to focusing on a specific part of an image. For example, babies this age can focus on the whole human face instead of just the eyes. As a result, they are much more responsive to human facial expressions. They also love looking at themselves in the mirror. Certain facial expressions such as closing the eyes, sticking out the tongue, blowing out the cheeks, moving the eyebrows up and down, and moving the head from side-to-side are known to engage an infant's attention.

By four months of age, an infant's range of vision has increased to several feet or more and she shows preferences for certain images over others. For example, infants this age look at pictures of dogs, apples, and boats for longer periods of time than other images. Also at this age, they develop name and sight recognition. If the objects in pictures that a baby sees and is interested in are named, this helps boost her vocabulary.

By six months of age, babies can see almost as clearly and as far as adults. They are also better at distinguishing small details. They can better see the world in three dimensions. They are also better at coordinating their eye muscles to focus on and follow objects. They can now predict where moving objects go as well as track moving objects from left to right in their field of vision.

By seven months, an infant can follow faster and faster movements with his eyes. He can easily follow the path of a moving object, predict where it will land, and grab this object with his hands. By eight months of age, infants have the same visual acuity as adults.

With respect to hearing and speech development, newborns already hear as well as adults. Research shows that babies are taking in sound while they are still in the womb. At birth, they turn their head toward familiar voices, especially their mother's. During the first month, babies pay close attention to human voices, especially high-pitched female voices speaking “baby-talk.” If the pitch of a voice is raised, the rate of speech slowed, certain syllables exaggerated, and the eyes and mouth opened more than normal, a baby's attention will be captured and she will smile. Newborns also prefer sounds of continuous monotony such as rain, mountain streams, ticking clocks, heartbeats, and ocean waves. These sounds are known to be soothing to babies since they mimic the sounds infants hear in utero.

Infants less than two months old are extremely sensitive to noise levels and do not like loud sounds. They often shut down or cry out in irritability when exposed to loud sounds; however, if offered the sound of a soft rattle or quiet music, infants become alert and turn their head and eyes to the source of the sound. Interestingly, babies remember some of the sounds they hear. Some even recognize a story when it is read over and over again by becoming quieter and looking more attentive.

By two months of age, an infant is able to repeat some vowel sounds (e.g., “ah”, “ooh”), especially if she has been exposed to human conversation repeatedly with clear, simple words and phrases. She also starts to coo. By three months of age, infants look for the source of a sound if it is not within their view.

By four months of age, infants start to notice not only the pitch and level of voices but also the individual sounds these voices make. They listen to the vowels and consonants being spoken and become aware of how these combine to form syllables, words, and sentences. At this age, infants begin verbalizing. They begin to babble, using many of the rhythms and characteristics of their native language. They can produce such sounds as “muh-muh” and “bah-bah”.

Progression beyond babbling, however, depends on the type and extent of language stimulation a child receives. This language stimulation includes songs, books, and conversation. When an infant says a recognizable syllable, it is important to repeat that sound back to her and to introduce simple words containing that sound. For example, if an infant says “bah, bah”, that sound should be repeated back to her and words such as “bottle” repeated. Also, infants at this age should be introduced to simple words like “baby”, “cat”, “dog”, “go”, “hot”, “mama”, and “dada”. A baby begins to understand many of these words and their meaning long before she says them.

By six months of age, babies vocalize single consonants. “D” and “B” sounds are the first consonants they produce with words such as “dada” and “baba”. They also start babbling reciprocally as well as imitating some noises.

By eight months, babies start babbling in consonant-vowel combinations over and over again (“bababababa”, “dadadadada”, “mamamamama”). They can better distinguish vowels and consonants at this age and can recognize sounds that they hear over and over. They also start repeating a few isolated words. Infants this age love poems and songs, especially with rhyme. These help them build their sound repertoires and develop skills needed for early reading readiness.

By nine months, babies understand a few words such as “no” and “bye-bye”. They babble more frequently and imitate vocalizations more often. They also start making sounds of recognizable syllables like “ba”, “da”, “ga”, and “ma”, and even say words such as “mama”, “bye-bye”, and “oh-oh”. They also begin linking sounds to meanings. They associate certain sounds with certain objects, such as “choo-choo” for train or “moo” for cow. Over the next several weeks, they learn the meanings of more words and can even respond to simple requests. A baby of this age looks at you when you call her name and even looks at other family members and pets when their names are mentioned. She also waves goodbye or blows a kiss when asked.

Between 12 and 20 months, toddlers begin to further develop their receptive language skills. They process speech much more rapidly and can thus better understand what is being said to them. At this age, toddlers understand many more words than they can say. At about one year of age, a toddler's babbling slowly begins to change into distinct words. The first spoken words are often the names of people or objects. They may also describe an action or a social expression such as “hi” or “bye-bye”. By 18 months of age, most toddlers say at least 20 words. They often point to objects in an attempt to ascertain the name of that object. Research shows that talking with toddlers and labeling objects and events for them increases their vocabulary. The more words a toddler hears, the more words he is likely to say and understand. Toddlers this age love simple songs and games involving sounds and words. These types of interactions are a great way to build a toddler's vocabulary through repetition while holding their interest. Once a toddler learns a new word or phrase, he will likely repeat it over and over again to ensure its mastery and correct usage.

With respect to learning, newborns and very young infants process information much more slowly than older children and adults. This is because they have very little of a substance called myelin covering the length of their brain cells. Myelin is needed for electrical signals to travel down brain cells efficiently and quickly. Consequently, speech to infants less than four months of age should be in a slow voice that pauses often. This gives the young child time to process what is being shown and heard. In addition, young infants become overwhelmed with prolonged images and sounds due to the immaturity of their nervous system. This can lead to irritability and crying. This is another reason for the importance of built-in pauses at regular intervals. Also, infants and young children like repetition and are fascinated by images that they see over and over again. Repetition is an integral part of the learning process in young children.

By four months of age, a baby's memory and attention span increase. She grasps the concept of cause and effect. For example, she realizes that every time she shakes certain objects (e.g., keys or bells) they make a sound; likewise, every time she drops an object on the floor, it elicits certain responses from her audience (e.g., laughter, “oh-ohs”). It is important for children this age to have objects they can use for these learning experiments (e.g., keys, plastic/wooden spoons, bells, unbreakable cups) and to test their theories. It is at this age that infants become more interested in toys, especially toys they can shake bang, throw or drop.

By six months of age, babies learn the principle of object permanence. In other words, they realize that objects continue to exist even when they are out of sight. That is why peek-a-boo and other “hiding” games are such a thrill for them at this age.

At eights months of age, an infant has an attention span of two to three minutes, during which she can focus on one activity. She enjoys playing with ordinary household objects such as wooden spoons, egg cartons, and plastic containers of all shapes and sizes. She wants to use familiar objects in new ways. Whereas at six months of age an infant liked playing with a certain box, by eight months of age, she wants to put an object in that box and see what happens.

It is these small changes that help infants learn to detect small differences between what is familiar and what is new. Objects too familiar will not capture their attention; things that are too new can be confusing or even frightening. Eight month olds are also always dropping, rolling, throwing, waving or submerging familiar objects to see how these objects behave. These observations are full of learning opportunities. Such observations help them learn about shapes (e.g., some things roll and others don't), sizes (e.g., some things fit inside others), and textures (e.g., some things are soft while others are rough).

By nine and ten months, infants begin to better understand the concept of object permanence. At eight months of age, if a toy is hid under a blanket, they pick up the blanket and look for it underneath. By ten months, if that same toy is hid and then removed when they are not looking, children start looking for it elsewhere. At this age, children's memories dramatically improve and they come to expect routines and rituals. Between nine and 12 months, many infants become attached to one special toy or object, which serves as a stand in for mom and also as a way to soothe them.

A one year old has an attention span that can be as long as fifteen minutes. A one-year-old child also looks at the correct picture in a book when that image is named. Children at this age begin using objects correctly such as drinking from a cup, eating from a spoon, dialing the phone, and listening to the receiver. They also begin to employ these objects in fantasy play.

Children over the age of one year learn best by using their senses to actively explore the world around them, including everyday objects in their environment. They learn about sizes, colors, and shapes through objects and toys that are varied in size, shape and color. They learn the alphabet through repetition and the use of words commonly associated with the ABCs. They learn numbers through repetition and the use of objects they can count and sort. They learn about various sounds by being exposed to different kinds of music. They begin to interact socially through imitation games played back and forth.

The importance of visual and auditory stimuli in this skill acquisition process establishes the basis for the sights and sounds seen and heard in videos in accordance with the principles of the present invention. Babies typically learn realistic symbols such as photographs first and then later begin to understand more abstract symbols like line drawings and letters. In the first videos, infants are introduced to realistic photos of familiar objects and images in their world. In subsequent videos, some of these realistic objects and images are broken down into their symbolic counterparts (e.g., line drawings; 3-dimensional graphic form).

Infants and young children also learn by mimicking what they see and hear. In videos in accordance with the principles of the present invention, they learn about sounds and word structure through exposure to books in an electronic format containing familiar characters, objects, and events. They also begin to identify letters of the alphabet through these books because the letters are linked to familiar objects and the sound of each letter is stressed repeatedly through alliteration and rhyming. The sights and sounds in these books are repeated over and over in an increasingly more complex story line with each sequential video. As infants become toddlers, they begin to understand the sequence of a story (i.e., beginning, middle, and end) as well as understand the written words within that story used to symbolize ideas and thoughts. In a later video for toddlers, the images become more complex as does the accompanying text and narration.

Videos in accordance with the principles of the present invention have been developed to target infants' and young children's developmental needs by age instead of by topic. As opposed to prior videos directed at a wide range of ages that attempt to cover specific topical categories such as language, music, and people, videos in accordance with the principles of the present invention are targeted to children within a much narrower age group (for example, up to three months, three to six months, six to nine months, etc.) and offer a broad array of content covering multiple topics within each video. Instead of forcing concepts into artificial learning categories, videos in accordance with the principles of the present invention use specific images and sounds to introduce various learning concepts to infants and young children based on the most recent scientific knowledge of their age specific developmental abilities.

Since the majority of these abilities develop within narrowly defined periods in the first eighteen months of life, videos of the present invention target infants and young children within these narrow age groups. Although the age group of each video is narrow, the content of each video of the present invention is quite broad and covers an array of topics. This is because learning and intellectual development within these narrowly defined age groups not only involves the simultaneous acquisition and coordination of a number of visual and auditory abilities as well as knowledge and judgment, but also is equally dependent on multiple stimuli directed at each of these skill sets. Significantly, videos in accordance with the principles of the present invention are designed to enhance learning by focusing appropriate content on age categories rather than topical categories during the period of rapid brain growth in infancy and early childhood. By offering a child a head start at this early, critical developmental stage, it is believed that that advantage will follow the child throughout her development.

The following are non-limiting examples of the concepts and images found in videos in accordance with the principles of the present invention.

### EXAMPLE

### Up to 3 Months Videos

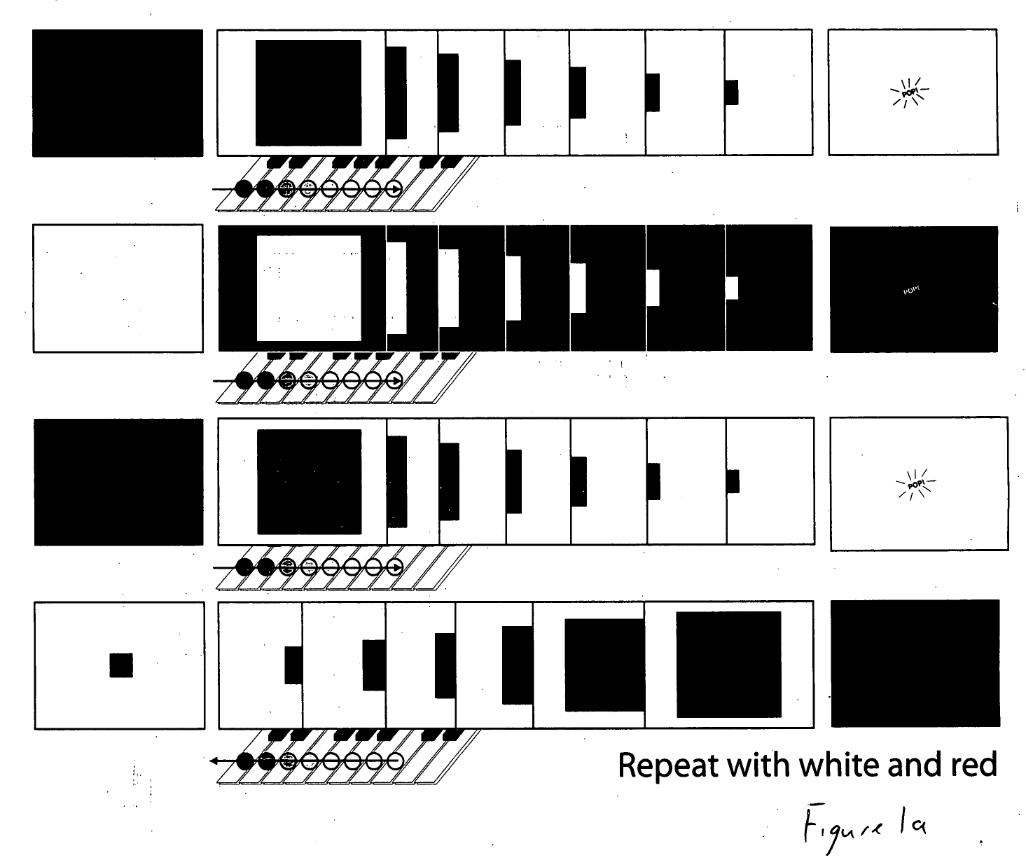

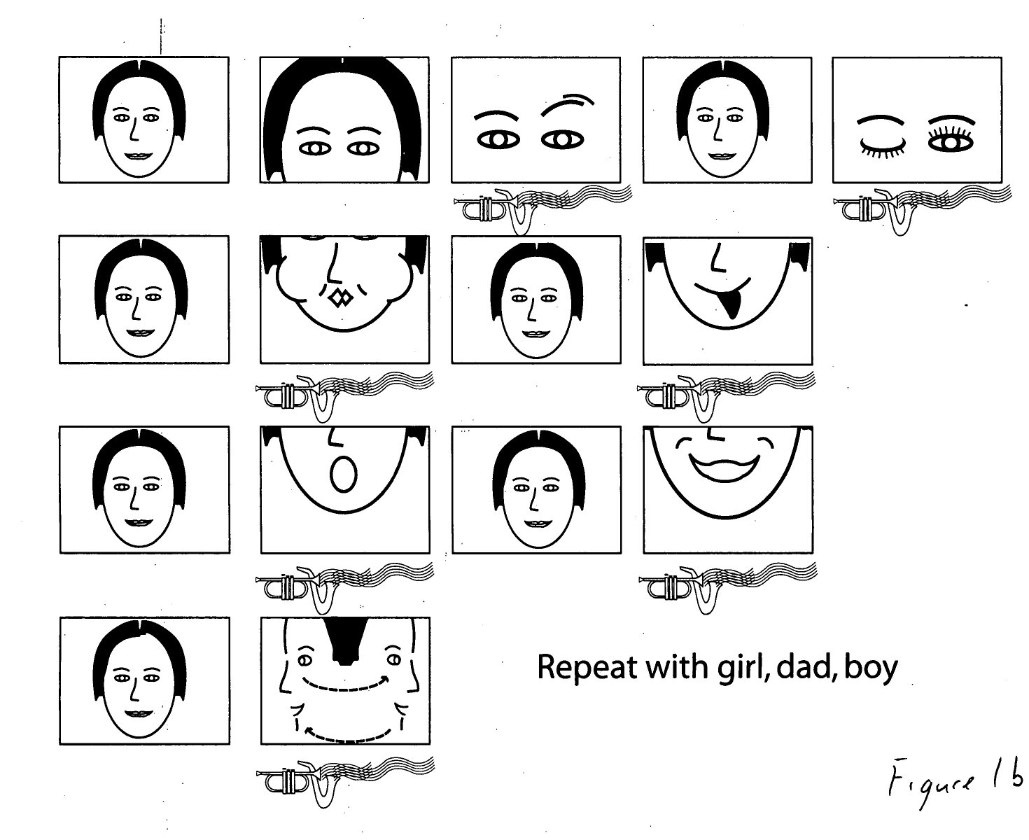

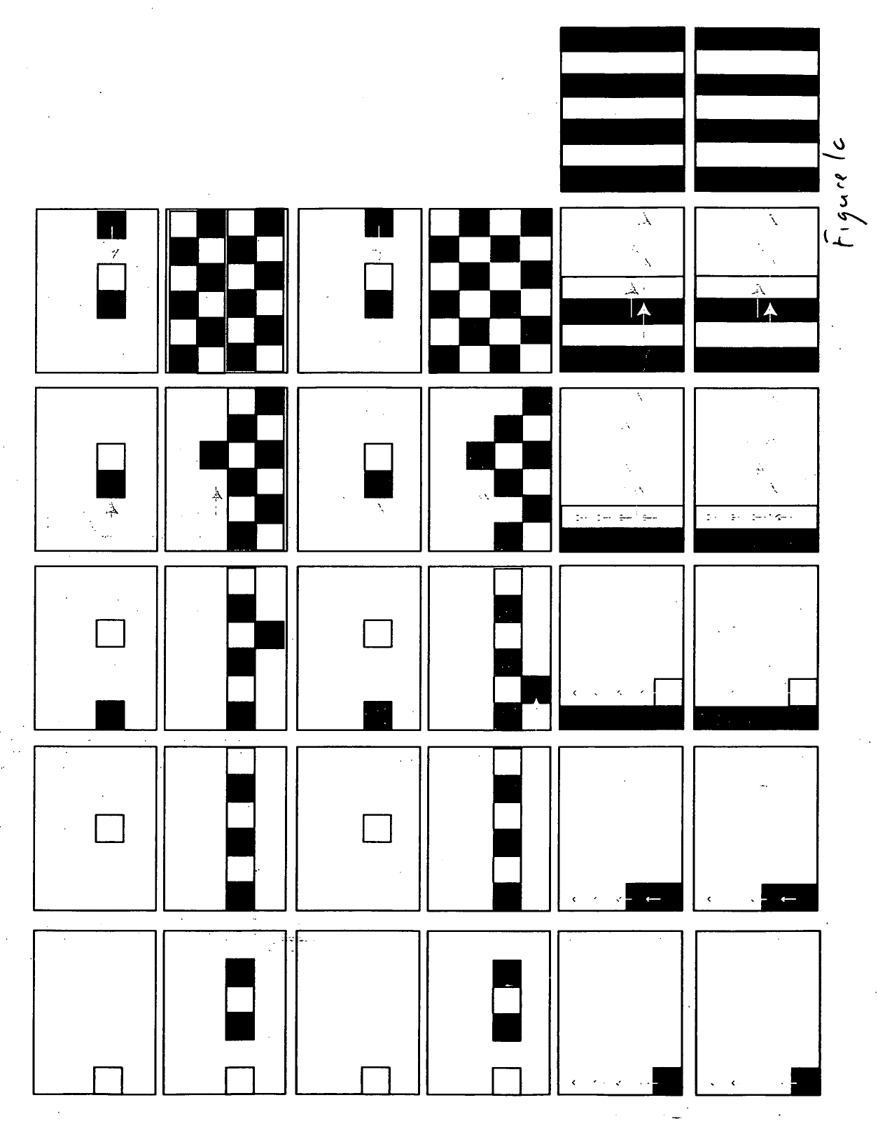

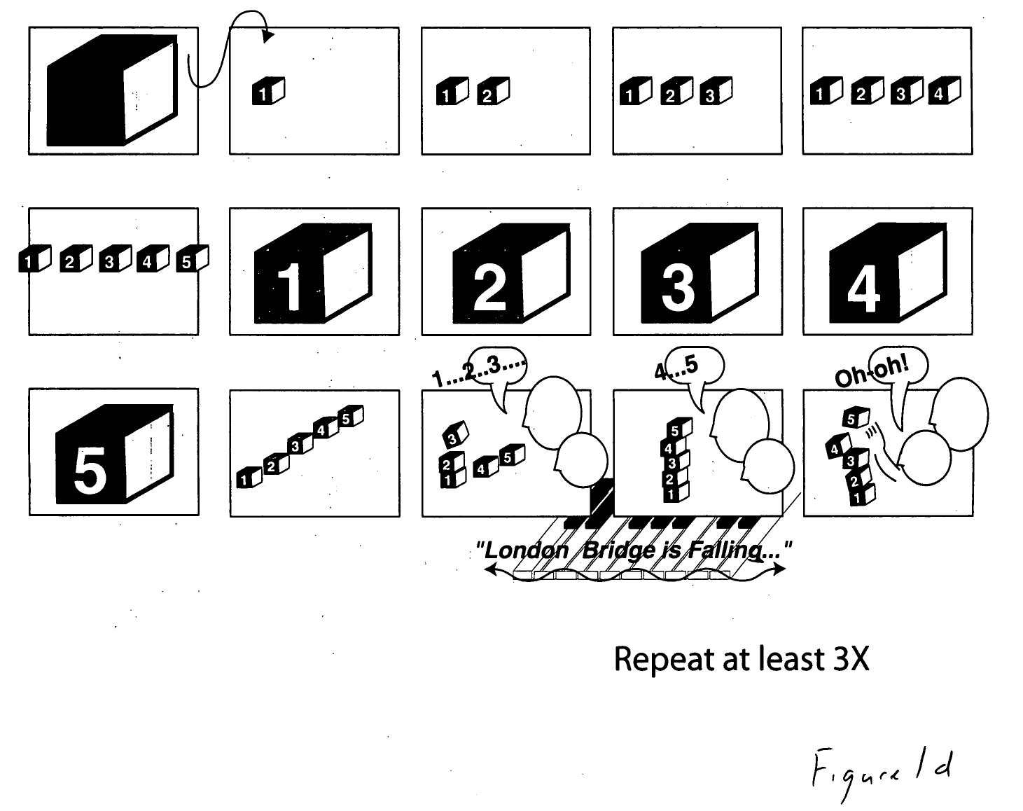

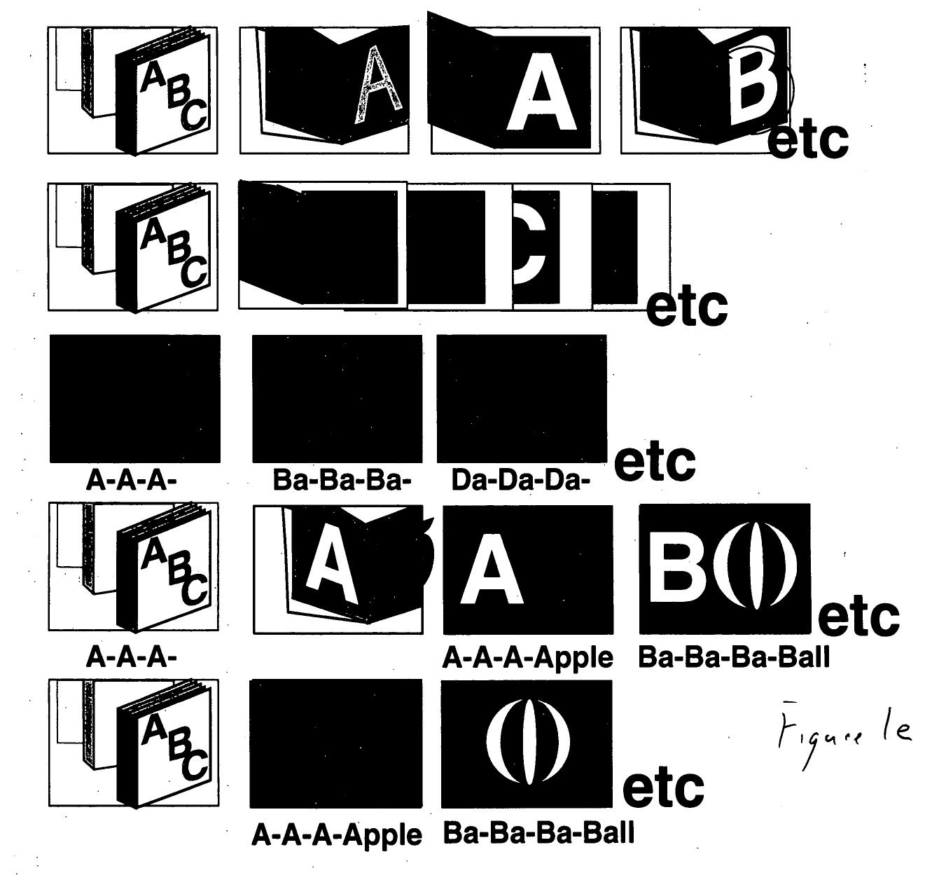

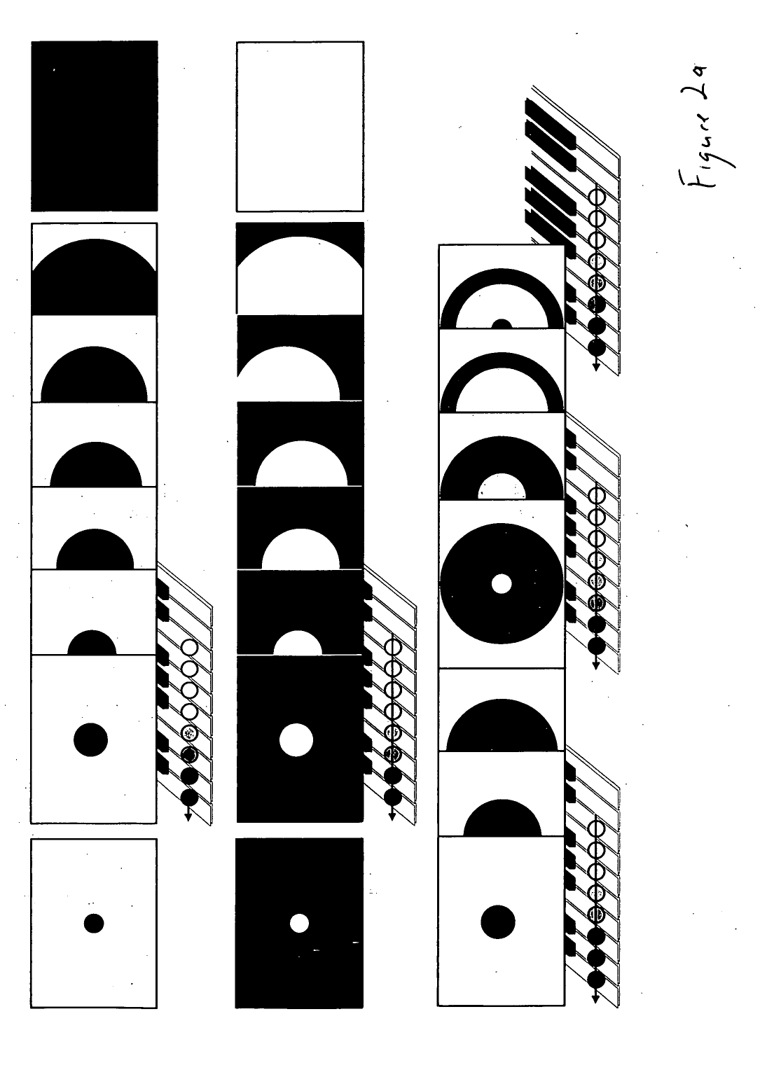

FIG. 1 shows a storyboard of a first example video in accordance with the principles of the present invention. The images and sounds seen and heard in this example video are formulated to the developmental stage and needs of infants three months of age or less; however, it should be understood that videos in accordance with the present invention are not limited to specific age ranges. Images, including both graphical and realistic, are what infants in this age range recognize and what holds their interest. The images are designed to encourage and enhance the natural development of visual recognition of infants this age.

More specifically, the graphical images are high contrast images in black and white or light and dark because infants at this stage of development do not yet have finely tuned color vision. When color images or pictures are seen, they are limited to bold colors, particularly red, since infants this age prefer have a limited range of color recognition and differentiation, preferring red to other primary colors.

The graphical images begin at the periphery of the screen and gradually move to the center. This is because babies are born with peripheral vision and only after a few weeks to months do they develop the ability to focus on objects in the center of their visual field. By starting the images at the periphery and working towards the center, infants within this age range have time to focus and follow the object. Examples of this can be seen in FIG. 1a.

In addition to simple shapes and linear images, babies this age show preference for the pattern of human faces and facial expressions. Although they do not understand facial expressions, babies can copy them from birth. In this example video, adults and children engage in a variety of facial expressions. Their facial movements are accompanied by simple musical sequences. Since young infants have difficulty discerning details and become overwhelmed with complex images, the camera focuses on a close-up view of one set of facial features at a times such as the mouth, eyes, etc. moving in a particular way. Examples of this can be seen in FIG. 1b.

In addition to the graphical images that begin at the periphery of the screen and gradually move to the center, in this example video graphical images of easily recognized shapes and patterns are utilized such as alternating light and dark stripes and checkerboards. Examples of this can be seen in FIG. 1c. In addition, infants are introduced to cause and effect by seeing children building a tower from blocks and then knocking them down. The infants hear the words “oh-oh” just prior to the blocks tumbling down followed by laughter and clapping after they have fallen. These actions are repeated several times to help establish the cause and effect concept. An example of this can be seen in FIG. 1d.

Although a child's hearing is fully developed at birth, babies are extremely sensitive to noise levels. Infants at this stage do not like loud complicated sounds. Instead, they prefer softer, simpler, more soothing sounds. In particular, babies prefer the human voice to other sounds, particularly that of women because of its higher pitch. In this example video, the narrator has a high-pitched maternal voice. Also, since young infants process what they see and hear more slowly, the narrator speaks at a reduced rate of speech and exaggerates certain syllables. The music in the up to three months example video is composed principally of single or isolated musical noted played slowly and softly along with nursery rhymes and songs known to be soothing to infants. The sounds heard in this example video are repeated over and over to enhance memory skills of young infants since research shows that babies remember some of the sounds they hear repeatedly.

By two months of age, an infant can repeat certain vowel sounds such as “aah” and “ooh” as well as certain consonant sounds such as “D”, “B”, and “G”. An infant's ability to mimic these sounds is enhanced by hearing them in conjunction with clear simple words and phrases. The up to three months example video introduces these age specific sounds in a fun and interesting way through the use of colorful book images. The narrator emphasizes these sounds as the images are shown on screen and the associated words are spoken. The narrator repeats these sounds and words several times since repetition helps build the sound repertoires of infants and begins to develop their reading readiness. Research shows that babies can recognize a story when it is read over and over to them by becoming more quiet and attentive. Examples of this can be seen in FIG. 1e.

The images in the book are realistic symbols such as photos since that is what babies typically recognize first. Understanding of abstract symbols occurs a little later in development. The up to three months example video also uses simple children's poems, nursery rhymes and songs to reinforce the vowel sounds and the “D”, “B”, and “G” consonant sounds

At this age, prolonged images and sounds can lead to irritability and crying in infants because of the immaturity of their nervous system. Each series of images in the up to three months example video runs a short period of time, for example up to about three minutes, after which there is a break of about 30 seconds. During these breaks, soothing images of under-water scenes that mimic the in utero visual experience are shown accompanied by accompanied by sound recordings that mimic the in utero auditory experience. These built-in breaks are needed to give the infants time to process what they see and hear without becoming overwhelmed.

### EXAMPLE

### 3 to 6 Months Video

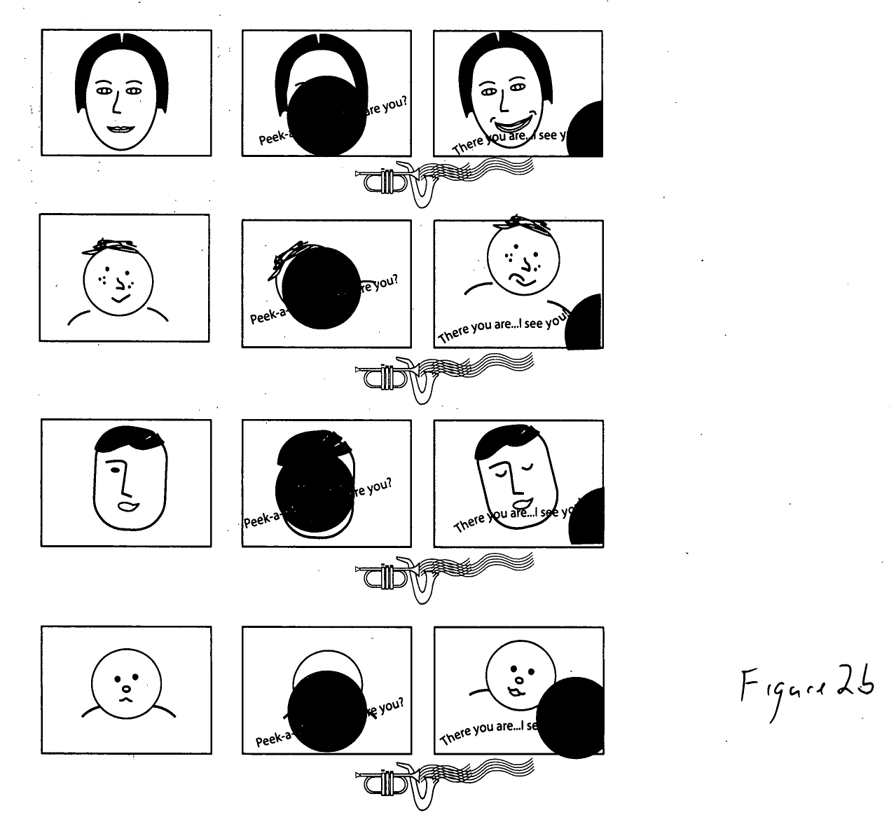

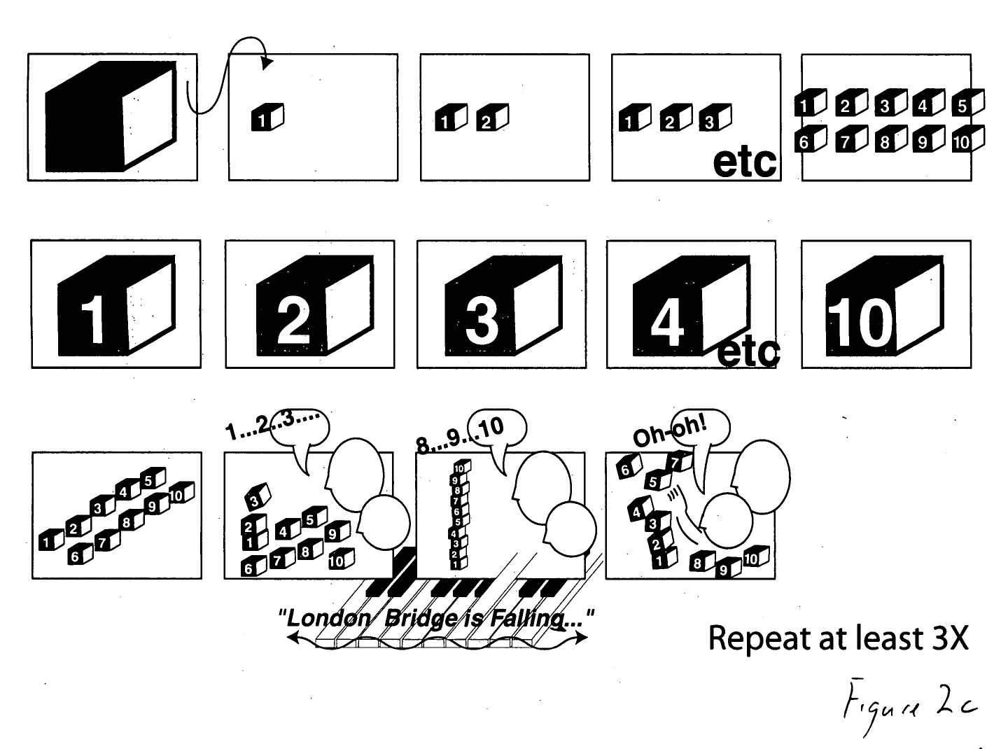

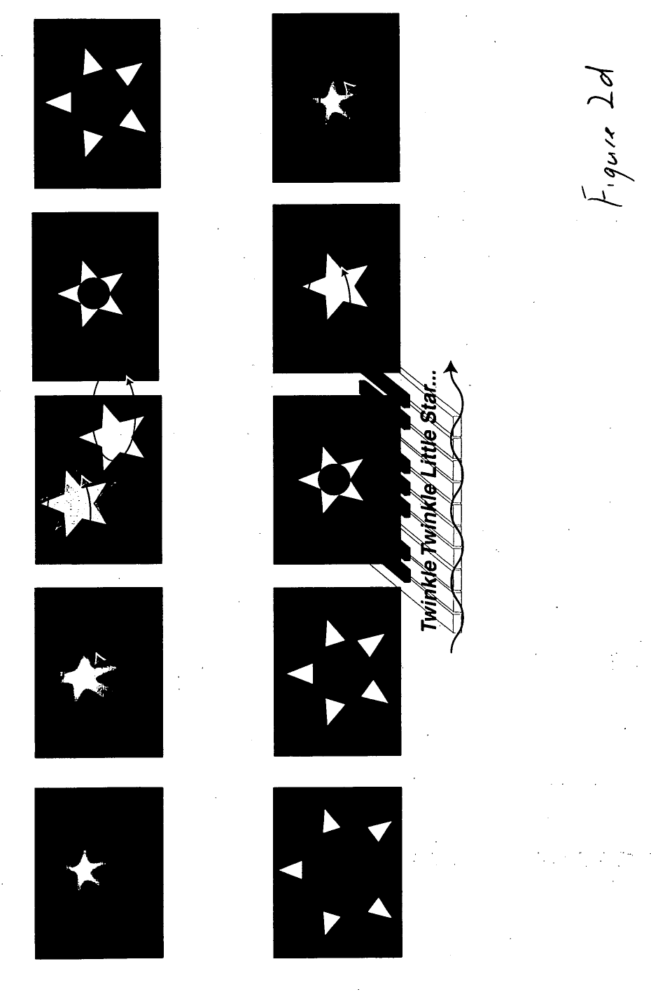

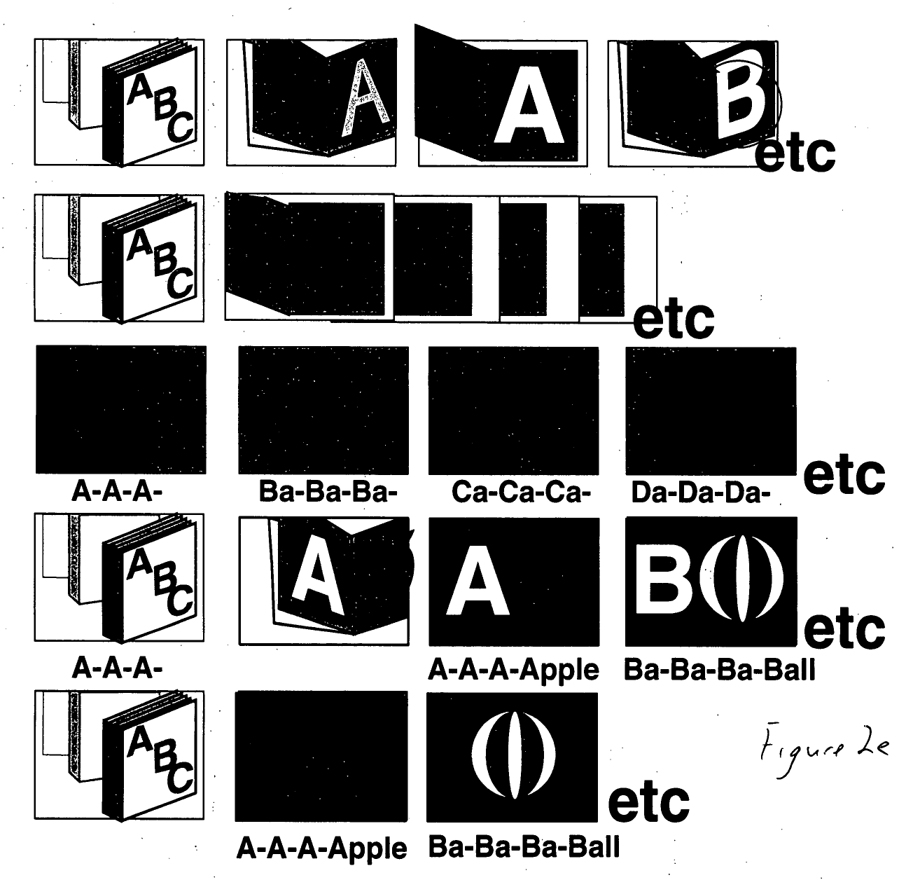

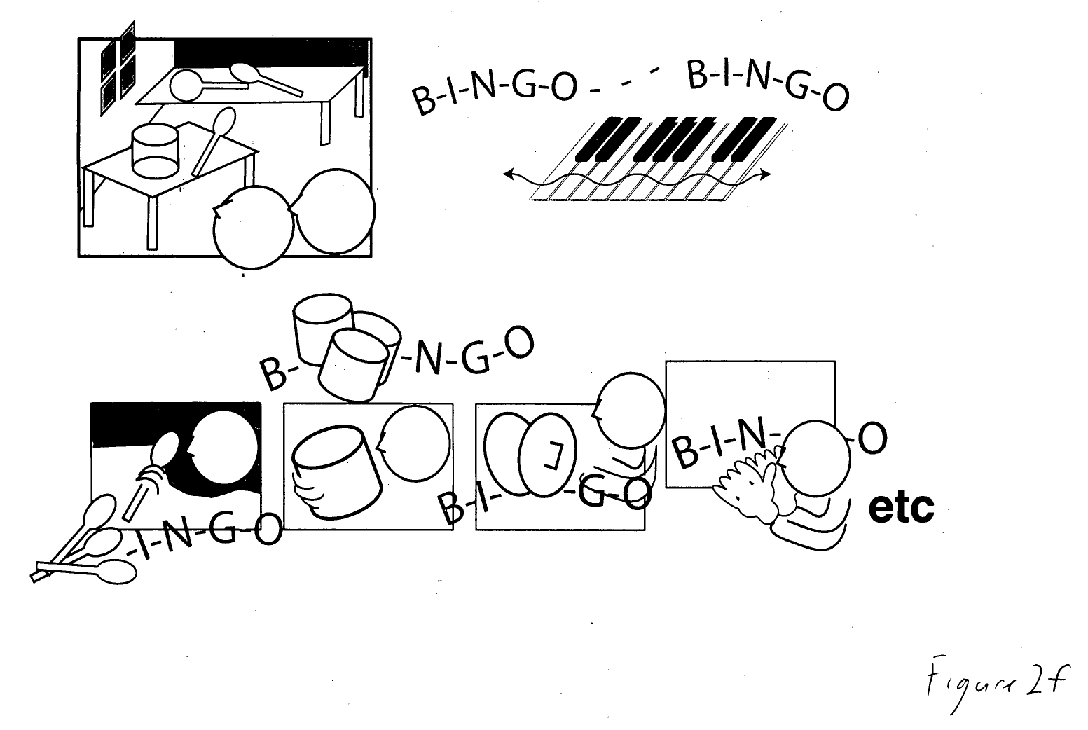

FIG. 2 shows a storyboard of a second example video in accordance with the principles of the present invention. The images and sounds seen and heard in this example video are formulated to the development stage and needs of infants from three months to six months of age; however, it should be understood that videos in accordance with the present invention are not limited to specific age ranges. By three or four months, an infant's vision has matured dramatically. She is able to discern all colors within the spectrum and their many shades. She can better focus on and track objects as they move. As a result, she seeks out more stimulating objects and images at which to look.

The images seen in this example video are geared to the visual abilities of children within the three to six month age range. The images are in a variety of colors and involve more complex graphics. Rather than simple squares and linear images of the first example video, the images in this example video are of more complicated circular patterns. In addition, the more advanced images in this example video can include bull's eyes that change color and move in rapid sequence. Examples of this can be seen in FIG. 2a.

The human faces of the first example video are again utilized. In this example video they are shown in their entirety engaging in various expressions. The human faces are also used to reinforce the more advanced images in this example video. Examples of this can be seen in FIG. 2b.

By four months of age, infants begin learning two very important concepts that will serve as foundations for higher functioning. The first concept is that of cause and effect. That is to say the certain actions elicit certain responses. In this example video, infants learn cause and effect by seeing children building a tower from blocks previously shown in the first example video and then knocking them down. The infants hear the words “oh-oh” just prior to the blocks tumbling down followed by laughter and clapping after they have fallen. An example of this can be seen in FIG. 2c. These actions are repeated several times to help establish the learning of the cause and effect concept. The second concept infants this age begin understanding is that of object permanence. That is to say that objects and people continue to exist even when they are not in view. In this example video, adults and children play cover/uncover and peek-a-boo games highlighting the idea of object permanence. Both the concept of cause and effect and that of object permanence are fully mastered by six months of age.

Infants this age are also beginning to develop three-dimensional perception and can keep their eyes on objects as they move toward and away from them. Taking the familiar object of a star, the three to six months example video transforms it into its graphical image and then breaks it down into its simpler components of several interconnected triangles. During this transformation, the star and its respective graphical patterns spin around and move from side to side as well as near and far. This break down of a real world object to its representative line drawings teaches infants to begin making the connection between actual images and their abstract symbols. An example of this can be seen in FIG. 2d. This understanding of the meaning of symbols establishes one of the fundamental principles of early literacy in children.

By four months of age, infants babble routinely, produce more consonant sounds and can even say “mama” and “dada” nonspecifically. They listen to the vowels and consonants people make and begin learning to mimic and combine them. An infant will first produce the consonant sounds “D”, “B” and “G” followed shortly thereafter by “M” and “P”. Over the next several months, an infant combines these consonant sounds with vowel sounds previously learned and begins babbling these consonant and vowel combinations over and over again. By six months of age, babies develop name and sight recognition. They quickly understand the meaning of many words and associate them with its corresponding image/object well before they can say them.

The more exposure infants have to these sounds, the more they imitate them. Continual repetition of these sounds to babies is important, as is introducing simple words that contain these sounds. The three to six months example video adds the sounds “m” and “p” and reinforces the consonants “D”, “B” and “G” and the vowels introduced in the previous example video. These sounds are reinforced through the use of simple words repeated over and over again. These sounds and words are linked to real world images familiar to babies this age using the electronic picture book introduced in the first example video. An example of this can be seen in FIG. 2e.

Infants between three and four months of age love simple rhyming songs with a repetitive pattern. They can recognize sounds they hear over and over again in these songs and begin repeating them. Songs are a way for infants and young children to remember what they have learned. This helps them build their sound repertoires and develop early reading readiness. The three to six month example video uses these types of songs (i.e. Twinkle/Twinkle, ABC song, BINGO) as a learning tool for this specific purpose.

This example video introduces children in a playroom setting. The children play along to a simple song such as “B-I-N-G-O.” An example of this can be seen in FIG. 2f.

By three or four months, an infant's memory and attention span increase so that their interest in the same series of images extends for longer periods of time. Each series of images in the three to six months example video can run longer than the previous example video, for example up to about five minutes, after which there is a break of a short period of time, for example about 30 seconds. During these breaks, soothing sounds such as rain, a mountain stream, and ocean waves are heard while corresponding images of rain, a mountain stream, and ocean waves are shown. These built-in breaks help give the infants time to process what they see and hear without becoming overwhelmed.

### EXAMPLE

### 6 to 9 Months Video

The images and sounds seen and heard in this example video are formulated to the development stage and needs of infants from six months to nine months of age; however, it should be understood that videos in accordance with the present invention are not limited to specific age ranges.

There is a large normal variation for the acquisition of pre-linguistic skills in this age range. Progression beyond babbling depends on the language stimulation a child receives. This type of stimulation includes reading books to infants and singing songs to them over and over again. This example video incorporates the images and objects seen in the first two example videos into more complex scenes and stories. In addition, this example video uses the simpler songs and music featured in the first two example videos as basic melodies but adds more complex chords and musical sequences to them.

The square, circle and triangle shapes introduced in the first two example videos are reintroduced in this example video along with new shapes of a rectangle. These shapes change from their 2-dimensional to their 3-dimensional counterparts. The objects morph from their respective shapes to a graphic representation of that shape and then finally to a real object resembling that shape. For example, the square turns into a block and then into a cardboard box. Other examples include the circle changing into a sphere and then into the earth or a triangle changing into a pyramid and then into a hat. This transformation process then reverses itself so that the real world objects sequentially break down to their graphic counterparts and then to their respective shapes. The graphic or line drawing image of the shape is added in this example video to introduce the idea that abstract symbols often stand in for realistic images. Although young infants do not understand the use of symbols, older infants start to recognize and derive meaning from symbols, which is an essential part of literacy development. In addition, multiple images of each shape introduced in the prior example video are shown in different colors. These are used to reinforce the concepts of color differentiation and sequential counting.

Between six and nine months of age, infants start imitating the facial expressions of others. The six to nine months example video adds more complex facial expressions to those introduced in the three to six months example video - including silly expressions and multiple expressions occurring simultaneously. The narrator will label both the body parts used to make the expressions and the action/expression itself. As in the prior example videos, both adults and children are seen making these expressions.

By four months of age, infants can better focus on and track objects as they move. By about six months of age, they can track even very small objects moving quite quickly. In this example video, the simple shapes of the square, circle, triangle and rectangle will move about the screen individually in a predictable pattern accompanied by a corresponding musical sequence. This enables infants to begin associating particular sights with specific sounds as well as to begin learning patterns and predicting where familiar objects will move based on repetitively reinforced visual and auditory cues.

By eight months infants begin associating sounds with objects such as “choo choo” for train or “moo” for cow. Babies over six months begin to link sound and meaning which reflects the beginnings of language development. In this example video, a small play/narrative story is staged using images the children have seen in the prior example videos: language is kept short and simple; objects are shown more than once; and names repeated often. The narrator adds a high-pitched singsong character to the speech, which is known to help babies develop the fundamentals of speech. The images used in these short narratives will come directly from images familiar to the infants from the electronic book sequence in the first two example videos.

The playroom setting seen in the three to six month example video is reintroduced in this example video. In this sequence of images, the children choose several objects from the playroom to line up on stage. Some of these objects will be ones shown in prior example videos. They cover each one and then uncover it sequentially with a container (the peek-a-boo container is designed for the purpose of teaching object permanence) while narrator says “peek-a-boo; where is it?” These same actors then take some of the objects or toys they were playing with and put the objects into various containers. Then they turn the containers upside down and have the object fall out. In an additional sequence, before the object is poured out, the container is shaken to have object make the sound. Without showing the object in the container, narrator says, “what is it?” and then says the name of the object once it is out of the container. This sequence of images helps to reinforce the concepts of name-sight recognition, object permanence and cause and effect

Additionally, the narrator asks questions in this example video about the specific scene such as “where's the ball?” There will be a few seconds of delay before the camera highlights and then zooms in on the ball, giving time for baby to respond to the narrator's question. Pictures of animals and objects are shown along with the corresponding sounds they make in the real world. Then the narrator will ask the audience for the particular sound an object makes. Again, there will be a few seconds of delay, allowing baby to respond before the corresponding sound is heard. By about nine months of age, babies begin understanding words and responding to simple questions and requests. They also start associating words with objects, gestures and events. The images and sounds featured in this example video sequence, including the related question/answer format help reinforce this concept of name-object recognition.

By one year of age, babies can express their feelings through gestures, sounds and facial expressions. To reinforce this concept, children and adults are shown in this example video demonstrating a variety of emotions that are then labeled by the narrator. In addition, the children and adults engage in a variety of simple body movements that are also narrated. These include clapping hands, stomping feet, turning around and everyday activities such as putting on a hat, eating an apple, and brushing hair/teeth. The audience is then encouraged to repeat these expressions and gestures by the narrator as their corresponding images are repeated several times.

Now the children in the playroom are seen sequentially pointing to and naming the toys that they choose. They then play with the toys, which are showcased via close-up images of the toys and their function. These toys include: stacking toys in various sizes, shapes, and colors (including the previous blocks); household objects seen before (used to make music/noises); toys that move (boats floating, cars/trucks moving, push-pull toys, bouncing balls); toys that do something when pushed, turned on, etc. (music box, metronome, toys that squeak or make sounds); toys that can be filled/dumped; and puzzles with large fitting pieces. Depending on the toys chosen, the children will illustrate examples of cause and effect and object permanence as they play. With respect to the blocks, the children are shown counting them sequentially up to 20. This will reinforce the concept of sequential numbering. Also, color recognition will be reinforced through the use of similar objects that vary in color. The children will name the various colors as they play with the objects. The objects and toys with which the children played in the prior two example videos will be shown in the background within this playroom.

Since infants this age like to do things over and over to try and figure out how things work, the children are shown playing with these objects repeatedly. Repetition also builds their self-confidence and strengthens particular connections in their brains.

Two to three older children are introduced in this example video playing hand games together such as Patty-Cake, London Bridge and Wheels on the Bus. Some of these songs were introduced in the prior example videos. Additionally, these children will be seen dancing to other familiar nursery rhymes and children's songs.

Each series of images in the six to nine months example video can run longer than the previous example video, for example up to about ten minutes, after which there is a break of about 30 seconds. During these breaks, soothing sounds such as rain, a mountain stream, and ocean waves are heard while corresponding images of rain, a mountain stream, and ocean waves are shown. These built-in breaks give the infants time to process what they see and hear without becoming overwhelmed.

### EXAMPLE

### 9 to 12 Months Video

The images and sounds seen and heard in this example video are formulated to the development stage and needs of infants from nine months to 12 months of age; however, it should be understood that videos in accordance with the present invention are not limited to specific age ranges. The sounds and images in this example video reinforce the concepts of name-object recognition, cause and effect and object permanence.

The images seen and named in the first three example videos during the electronic book sequence are used again in a continuation of the story/scene introduced in the prior example video. Additionally, the narrator asks questions in this example video about the specific scene such as “where's the ball?” There will be a few seconds of delay before the camera highlights and then zooms in on the ball, giving time for baby to respond to the narrator's question. Pictures of animals and objects are shown along with the corresponding sounds they make in the real world. Then the narrator will ask the audience for the particular sound an object makes. Again, there will be a few seconds of delay, allowing baby to respond before the corresponding sound is heard. By about nine months of age, babies begin understanding words and responding to simple questions and requests. They also start associating words with objects, gestures and events. The images and sounds featured in this example video sequence, including the related question/answer format help reinforce this concept of name-object recognition.

By one year of age, babies can express their feelings through gestures, sounds and facial expressions. To reinforce this concept, children and adults are shown in this example video demonstrating a variety of emotions that are then labeled by the narrator. In addition, the children and adults engage in a variety of simple body movements that are also narrated. These include clapping hands, stomping feet, turning around and everyday activities such as putting on a hat, eating an apple, and brushing hair/teeth. The audience is then encouraged to repeat these expressions and gestures by the narrator as their corresponding images are repeated several times.

The “playroom” setting shown in the prior example videos is once again featured in this example video. Now the children in the playroom are seen sequentially pointing to and naming the toys that they choose. They then play with the toys, which are showcased via close-up images of the toys and their function. These toys include: stacking toys in various sizes, shapes, and colors (including the previous blocks); household objects seen before (used to make music/noises); toys that move (boats floating, cars/trucks moving, push-pull toys, bouncing balls); toys that do something when pushed, turned on, etc. (music box, metronome, toys that squeak or make sounds); toys that can be filled/dumped; and puzzles with large fitting pieces. Depending on the toys chosen, the children will illustrate examples of cause and effect and object permanence as they play. With respect to the blocks, the children are shown counting them sequentially up to 20. This will reinforce the concept of sequential numbering. Also, color recognition will be reinforced through the use of similar objects that vary in color. The children will name the various colors as they play with the objects. The objects and toys with which the children played in the prior two example videos will be shown in the background within this playroom.

Since infants this age like to do things over and over to try and figure out how things work, the children are shown playing with these objects repeatedly. Repetition also builds their self-confidence and strengthens particular connections in their brains.

Two to three older children are introduced in this example video playing hand games together such as Patty-Cake, London Bridge and Wheels on the Bus. Some of these songs were introduced in the prior example videos. Additionally, these children will be seen dancing to other familiar nursery rhymes and children's songs.

Each series of images in the nine to 12 months example video can run longer than the previous example video, for example up to about 20 minutes, after which there is a break of about 30 seconds. During these breaks, soothing sounds such as rain, a mountain stream, and ocean waves are heard while corresponding images of rain, a mountain stream, and ocean waves are shown. These built-in breaks give the infants time to process what they see and hear without becoming overwhelmed.

### EXAMPLE

### 12 to 15 Months Video

The images and sounds seen and heard in this example video are formulated to the development stage and needs of toddlers from 12 months to 15 months of age; however, it should be understood that videos in accordance with the present invention are not limited to specific age ranges. The sounds and images in this example video are again geared to reinforcing the concepts of name-object recognition, cause and effect and object permanence. The concepts are key to future learning and development, and toddlers can more easily understand these concepts as they are continually and repeatedly exposed to images utilizing these concepts.

The settings for the image sequences seen in this example video are the electronic book and the playroom. This will also be the stage for images seen in the subsequent example video as well. Limiting the images and actions to these two settings will allow the emphasis of the example video to be on learning the specific concepts within a familiar context. Since toddlers this age have longer attention spans, a specific setting/scene can run for a longer period of time. The images seen and named in the first four example videos during the electronic book sequence are used again along with new images. In these more complex scenes, the characters find hidden objects, recognize shapes, colors, and numbers and use everyday objects correctly (e.g., brush, cup, telephone, steering wheel).

The children are again seen in the toy room. This time they choose more advanced skill toys with which to play. Again, they point and name the objects first before going to get them to play. These toys now include large and small toys (e.g., big teddy bear and little teddy bear), toys that have turning knobs and dials, wind up toys, puzzles with large pieces (putting shapes into their various holes), and a series of steps to climb.

The toys chosen by the children will be highlighted separately to reinforce certain concepts. For example, the children will be shown putting the correct pieces of a puzzle together while naming the puzzle piece's shape and color prior to its insertion into the puzzle. This will help reinforce shape and color recognition. Also, the children will count the steps on which they climb up and down to reinforce the concept of sequential number recognition. The children will also highlight objects of different sizes to reinforce the concept of spatial integration and size differentiation.

Lastly, the children will be seen opening a door (to be introduced as the “magical door to the world”) within the playroom that shows various real world images and scenes. In this example video, the children will open the door onto images of other children dancing and singing songs highlighted in previous example videos.

Each series of images in this example video can run longer than the previous example video, for example up to about 15 minutes, after which there is a break of about 30 seconds. During these breaks, soothing sounds such as rain, a mountain stream, and ocean waves are heard while corresponding images of rain, a mountain stream, and ocean waves are shown. These built-in breaks are needed to give the toddler time to process what they see and hear without becoming overwhelmed.

### EXAMPLE

### 15 to 18 Months Video

The images and sounds seen and heard in this example video are formulated to the development stage and needs of toddlers from 15 months to 18 months of age; however, it should be understood that videos in accordance with the present invention are not limited to specific age ranges. As in the prior example video, the sights and sounds in this example video reinforce the concepts of name-object recognition, cause and effect and object permanence. Again, these concepts are key to future learning and cognitive function and need to be emphasized repeatedly within the first eighteen months of life. The settings for the image sequences seen in this example video are also limited to the electronic book and the playroom (including the “magical door to the world”).

The images seen and named in the first five example videos during the electronic book sequence are used again along with new images. In these more complex scenes, the characters continue to find hidden objects, recognize shapes, colors, and numbers and use everyday objects correctly.

The children are again seen in the toy room. This time they choose more advanced skill toys with which to play. Again, they point and name the objects first before going to get them to play. These toys now include tricycle, dress-up clothes, and actual musical instruments that the children play including the piano, violin, drums, and trumpet. The tricycle will be used to introduce the concept of perspective and spatial orientation by having the children ride the bikes near and far on the screen. In addition, the children are shown putting on various items of clothing (hat, gloves, socks, shirt). The clothes are highlight and named. Also, the specific actions are labeled (e.g., buttoning up coat, lacing up shoes, etc.) When the children play the instruments, the same note sequences as in the previous example videos will be heard (a professional musician will be playing these noted although he/she will only be heard and not seen).

The children will open the “magical door” in this example video as well. This time, the settings show a playground. Children are shown pointing or recognizing familiar objects and images as they make their way around these areas. The children's movements also highlight the concept of fast vs. slow, up vs. down, over vs. under. The children dance and sing as they make their way around these areas.

Each series of images in this example video can run longer than the previous example video, for example up to about 20 minutes, after which there is a break of about 30 seconds. During these breaks, soothing sounds such as rain, a mountain stream, and ocean waves are heard while corresponding images of rain, a mountain stream, and ocean waves are shown. These built-in breaks give the toddlers time to process what they see and hear without becoming overwhelmed.

While the invention has been described with specific embodiments, other alternatives, modifications and variations will be apparent to those skilled in the art. Accordingly, it will be intended to include all such alternatives, modifications and variations set forth within the spirit and scope of the appended claims.

What is claimed is:

1. A children's educational video comprising:
multiple stimuli that introduce various learning concepts to infants and young children based on their age specific learning abilities.

2. The series of educational children's videos of claim 1 further wherein the age specific learning abilities comprise age specific abilities.

3. The educational children's video of claim 1 further wherein the multiple stimuli comprises use of light verses dark images and strong contrast patterns.

4. The educational children's video of claim 3 further wherein use of light verses dark images and strong contrast patterns comprises black and white or light verses dark.

5. The educational children's video of claim 3 further wherein use of light verses dark images and strong contrast patterns comprises black, white, and red.

6. The educational children's video of claim 1 further comprising frequent breaks of soothing images and sounds separating the different image sequences.

7. The educational children's video of claim 6 further wherein the frequent breaks occur about every three minutes.

8. The educational children's video of claim 6 further wherein during the breaks images of under-water scenes that mimic an in utero visual experience are shown accompanied by sounds that mimic an in utero auditory experience.

9. The educational children's video of claim 6 further wherein the frequent breaks occur about every five minutes.

10. The educational children's video of claim 1 further wherein the multiple stimuli comprises use of easily recognized shapes.

11. The educational children's video of claim 10 further wherein the easily recognized shapes are selected from the group comprising squares, stripes, checkerboards, and combinations thereof.

12. The educational children's video of claim 1 further wherein the multiple stimuli comprises graphical images that begin at the periphery of the screen and gradually move to the center.

13. The educational children's video of claim 1 further wherein the multiple stimuli comprises graphical images that change from two to three dimensional images.

14. The educational children's video of claim 1 further wherein the multiple stimuli comprises use a variety of human faces used to show facial expressions.

15. The educational children's video of claim 4 further wherein the facial expressions comprise a close-up view of one set of facial features at a time moving in a particular way.

16. The educational children's video of claim 1 further wherein the multiple stimuli comprises facial expressions demonstrating a variety of emotions.

17. The educational children's video of claim 1 further wherein the multiple stimuli comprises musical notes played slowly and softly along with nursery rhymes and songs.

18. The educational children's video of claim 1 further wherein the multiple stimuli comprises images repeated in the videos along with musical accompaniment.

19. The educational children's video of claim 1 further wherein the multiple stimuli comprises use of children's poems, nursery rhymes and songs to reinforce the vowel sounds and the “D”, “B”, and “G” consonant sounds

20. A series of educational children's videos comprising:
a first video for a first, younger age group having realistic images of familiar objects; and
a second video for a second, older age group having the realistic images of familiar objects of the first video, the second video breaking down the realistic images into their symbolic counterparts.

21. The series of educational children's videos of claim 20 further wherein the symbolic counterparts are selected from the group comprising line drawings, three dimensional graphic forms, and combinations thereof.

22. The series of educational children's videos of claim 20 further wherein the first, younger age group comprises about birth up to about three months, and the second, older age group comprises about three months to about six months.

23. A series of educational children's videos comprising:
a first video for a first, younger age group having a book in an electronic format containing images that is utilized reinforcing the idea that everything has a name; and
a second video for a second, older age group having the book in an electronic format containing images of the first video, the second video images becoming more complex.

24. The series of educational children's videos of claim 23 further wherein the first, younger age group comprises about birth up to about three months, and the second, older age group comprises about three months to about six months.

25. The series of educational children's videos of claim 23 further wherein in the first video, the book in an electronic format is large, simple, and has colorful images recognizable to the first, younger age group and, in the second video the book in an electronic format is large, simple, and has colorful images recognizable to the second, older age group.

26. The series of educational children's videos of claim 23 further wherein in the first video, the book in an electronic format is large, simple, and has colorful images recognizable to the first, younger age group and, in the second video, the images in the first video are shown within a specific story or scene.

27. The series of educational children's videos of claim 23 further wherein a narrator states the name of objects in the book in an electronic format repeatedly to reinforce name object recognition.

28. A series of educational children's videos comprising:
a first video for a first, younger age group having content on vision development, hearing and speech development, and learning directed at that first, younger age group; and
a second video for a second, older age group having content on vision development, hearing and speech development, and learning directed at that second, older age group.

29. The series of educational children's videos of claim 28 further wherein the first, younger age group comprises about birth up to about three months, and the second, older age group comprises about three months to about six months.

30. The series of educational children's videos of claim 28 further wherein the first, younger age group comprises about three months to about six months, and the second, older age group comprises about six months to about nine months.

31. The series of educational children's videos of claim 28 further wherein the first, younger age group comprises about six months to about nine months, and the second, older age group comprises about nine months to about 12 months.

32. The series of educational children's videos of claim 28 further wherein the first, younger age group comprises about 12 months to about 15 months, and the second, older age group comprises about 15 months to about 18 months.

33. The series of educational children's videos of claim 28 further wherein in the second video, a shape seen in the first video is reintroduced in a variety of colors.

4.6. The series of educational children's videos of claim 28 further wherein in the second video, an image seen in the first video moves about the screen in a predictable pattern accompanied by a corresponding musical sequence.

34. The series of educational children's videos of claim 28 further wherein in the second video, complex circular patterns are utilized.

35. The series of educational children's videos of claim 34 further wherein the complex circular patterns are selected from the group comprising bull's eyes, human faces, and combinations thereof.

36. The series of educational children's videos of claim 28 further wherein in the second video, more complex facial expressions are added to facial expressions introduced in the first video.

37. The series of educational children's videos of claim 28 further wherein the second video introduces and reinforces the concept of cause and effect through games.

38. The series of educational children's videos of claim 28 further wherein the second video introduces and reinforces the concept of object permanence through games.

39. The series of educational children's videos of claim 38 further wherein in the second video, images seen in the first video are evolved into more complexity.

40. The series of educational children's videos of claim 38 further wherein an image seen in the first video transforms into a three dimensional counterpart.

41. The series of educational children's videos of claim 28 further wherein an image seen in the first video is transformed into a real world image that has the same shape.

42. The series of educational children's videos of claim 28 further wherein in the first video, the consonants “D”, “B”, and “G” and the vowels are introduced.

43. The series of educational children's videos of claim 42 further wherein in the second video, the sounds “M” and “P” are added and the consonants “D”, “B”, and “G” and the vowels introduced in the previous video are reinforced.

44. The series of educational children's videos of claim 28 further wherein, in the first video during breaks images of under-water scenes that mimic an in utero visual experience are shown accompanied sounds that mimic an in utero auditory experience.

45. The series of educational children's videos of claim 44 further wherein, in the second video during breaks soothing sounds and images are used selected from the group comprising rain, a mountain stream, ocean waves, and combinations thereof.

46. The series of educational children's videos of claim 4 further wherein, in the second video during breaks soothing sounds are shown along with a corresponding image.

47. The series of educational children's videos of claim 46 further wherein the soothing sounds and images are selected from the group comprising rain, a mountain stream, ocean waves, and combinations thereof.

48. The series of educational children's videos of claim 28 further wherein, in the second video square and circle shapes introduced in the first videos are reintroduced along with new shapes of a rectangle and triangle.

49. The series of educational children's videos of claim 28 further wherein, in the second video graphic or line drawing image of a shape of the first video are formed to introduce the idea that abstract symbols often stand in for realistic images.

50. The series of educational children's videos of claim 28 further wherein, in the second video objects of the first video are shown up close and a distance away.

51. The series of educational children's videos of claim 28 further wherein, in the second video objects of the first video are shown hidden.
